(19) United States
(12) Patent Application Publication
(10) Pub. No.: US 2020/0383186 A1
(43) Pub. Date: Dec. 3, 2020

(54) Light Source Adjustment System

(71) Applicant: Gunitech Corp., Qionlin Township (TW)

(72) Inventors: Hsien-Jen Chiu, Qionlin Township (TW); Hsin-Yi Kao, Qionlin Township (TW); Huan-Ruei Shiu, Qionlin Township (TW)

(21) Appl. No.: 16/879,911

(22) Filed: May 21, 2020

Related U.S. Application Data
(60) Provisional application No. 62/853,211, filed on May 28, 2019.

(51) Int. Cl. H05B 45/14; H05B 45/40; H05B 47/19; H05B 47/165

(52) U.S. Cl. CPC H05B 45/14; H05B 47/165; H05B 47/19; H05B 45/40

(57) ABSTRACT

A light source adjustment system is disclosed. The light source adjustment system includes a signal generation module, a switch circuit, and a light emitting element. The signal generation module is used for generating a control signal. The switch circuit is electrically connected to the signal generation module for determining whether a power signal is outputted according to the control signal. The light emitting element is electrically connected to the switch circuit for emitting a light signal according to the power signal; wherein the signal generation module adjusts a generation ratio of the control signal so as to control a brightness of the light signal.

### BACKGROUND OF THE INVENTION

### 1. Field of the Invention

The present invention relates to a light source adjustment system, particularly to a light source adjustment system that can adjust the generation ratio of a control signal.

### 2. Description of the Related Art

In the prior art, the use of LEDs for lighting is a very common technology. However, the brightness adjustment of LEDs is mostly controlled by means of pulse width modulation (PWM) or dimmer (TRIAC) voltage adjustment. The method of modulating pulse width is to control the pulse width of a modulation signal, as shown in FIG. 1. FIG. 1 is a waveform diagram of a modulation signal in the prior art.

FIG. 1 represents modulation signals 91, 92, 93 with different pulse widths. When the pulse widths of the modulation signals 91, 92, and 93 are different, the LED power will vary accordingly and the brightness will change. However, the method of modulating pulse width affects the number of dimming stages according to the duty cycle limit. Thus, there is a limit for adjustment. Moreover, using a dimmer to adjust the voltage to a certain low voltage range will no longer be able to perform dimming operations. From the above, it can be seen that neither the pulse width modulation nor the dimming method of a dimmer can achieve the stepless dimming effect that is both low-cost and close to analog.

Accordingly, it is necessary to devise a new light source adjustment system to solve the problem in the prior art.

### SUMMARY OF THE INVENTION

It is a major objective of the present invention to provide a light source adjustment system having the function of adjusting the generation ratio of a control signal.

To achieve the above objective, the light source adjustment system in the present invention includes a signal generation module, a switch circuit, and a light emitting element. The signal generation module is used for generating a control signal. The switch circuit is electrically connected to the signal generation module for determining whether a power signal is outputted according to the control signal. The light emitting element is electrically connected to switch circuit for emitting a light signal according to the power signal; wherein the signal generation module adjusts a generation ratio of the control signal so as to control a brightness of the light signal.

### BRIEF DESCRIPTION OF THE DRAWINGS

FIG. 1 is a waveform diagram of a modulation signal of the prior art;

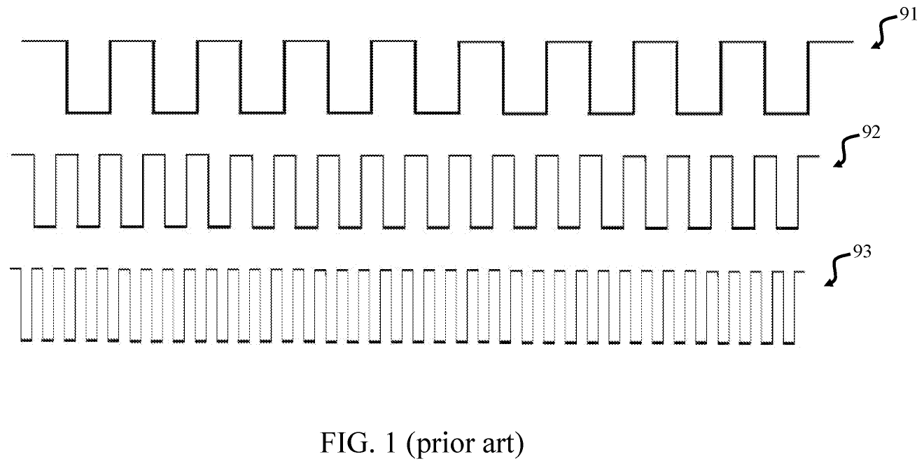

FIG. 2 is an architecture diagram of a light source adjustment system of a first embodiment of the present invention;

FIG. 3 is a waveform diagram of a control signal of the present invention; and

FIG. 4 is an architecture diagram of a light source adjustment system of a second embodiment of the present invention.

### DETAILED DESCRIPTION OF THE PREFERRED EMBODIMENT

Hereafter, the technical content of the present invention will be better understood with reference to preferred embodiments.

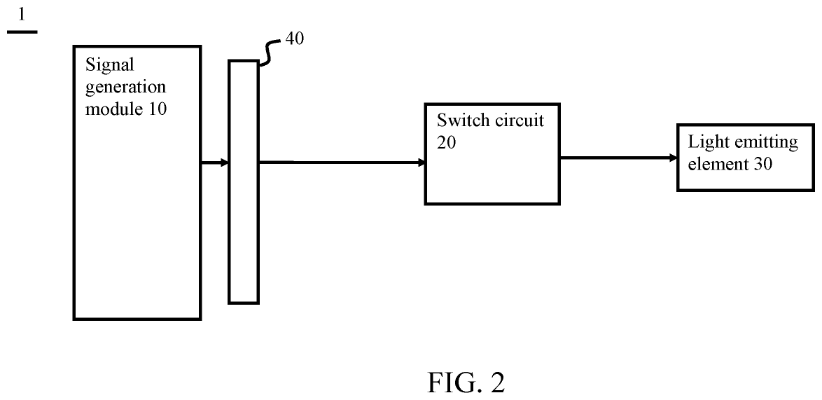

Hereafter, please first refer to FIG. 2, which is an architecture diagram of a light source adjustment system of a first embodiment of the present invention.

In the first embodiment of the present invention, the light source adjustment system 1 includes a signal generation module 10, a switch circuit 20, and a light emitting element 30. The signal generation module 10 is used for generating a control signal. The signal generation module 10 can be a Bluetooth low energy (BLE) module or a microcontroller unit (MCU), or any other structure that can be constructed by software programs with hardware devices or firmware with hardware devices able to generate signals on their own. The control signal generated by the signal generation module 10 can be a modulation signal, but the present invention is not limited thereto. The switch circuit 20 is electrically connected to the signal generation module 10 for determining whether a power signal is outputted according to the control signal. The switch circuit 20 is a metal-oxide-semiconductor field effect transistor (MOSFET), or other modules with the switch function, but the present invention is not limited thereto. The signal generation module 10 is connected to the switch circuit 20 through a general purpose input/output (GPIO) module 40. When the signal generation module 10 generates a control signal, the switch circuit 20 outputs a power signal.

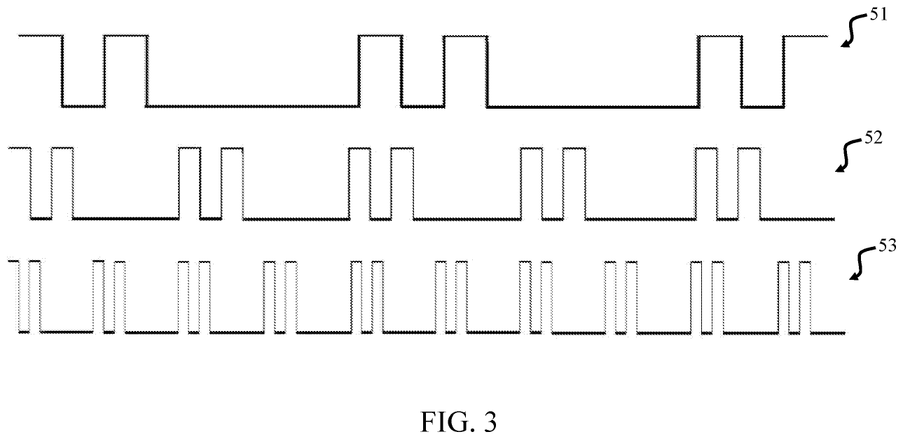

Hereafter, please refer to FIG. 3 for a waveform diagram of a control signal of the present invention.

As can be seen in FIG. 3, the pulse width of control signals 51, 52, 53 are different, and the frequency of the control signals 51, 52, 53 are the same as the modulation signals 91, 92, 93 in the prior art. However, the signal generation module 10 further adjusts the ratio of generating and pulse pumping the control signals 51, 52, 53, that is, intermittently generates the control signals 51, 52, 53. In an embodiment of the present invention, the signal generation module 10 can use firmware control to change the ratio of generating and pulse pumping the control signals 51, 52, 53, but the present invention is not limited thereto. Therefore, when the signal generation module 10 generates a control signal, the switch circuit 20 also outputs a power signal. When the signal generation module 10 suspends generating control signals, the switch circuit 20 also temporarily suspends output of power signals.

The light emitting element 30 is electrically connected to the switch circuit 20 for emitting a light signal according to the power signal. The light emitting element can be a white LED, a red LED, a blue LED or a green LED, but the present invention is not limited thereto. After the light emitting element 30 receives the power signal, it can obtain light signals with different brightness according to the frequency of control signals 51, 52, 53 as well as the waveform generation ratio of control signals 51, 52, 53. Accordingly, the signal generation module 10 adjusts the generation ratio of the control signal, that is, adjusts the frequency of the modulation signal and the generation ratio of the modulation signal to control the brightness of the light signal emitted by the light emitting element 30.

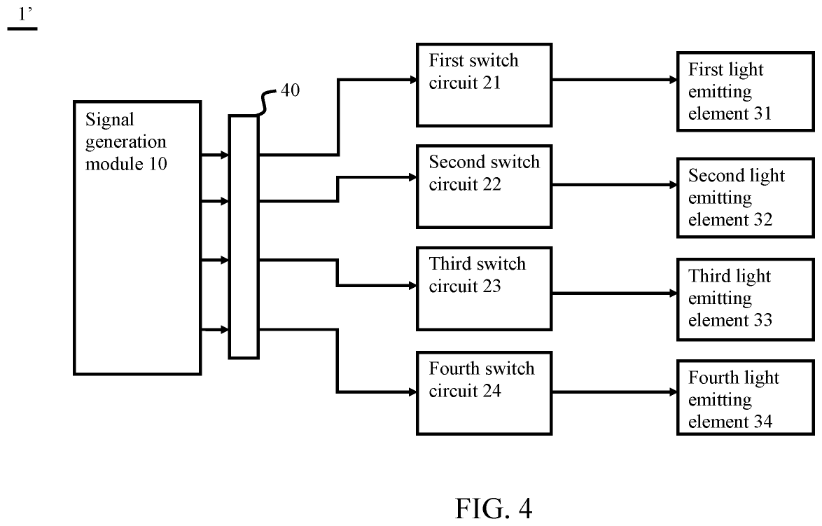

Then, please refer to FIG. 4, which is an architecture diagram of a light source adjustment system of a second embodiment of the present invention.

In the second embodiment of the present invention, the signal generation module 10 of the light source adjustment system 1′ can be connected to a first switch circuit 21, a second switch circuit 22, a third switch circuit 23 and a fourth switch circuit 24 via pins of the general purpose input/output (GPIO) module 40, so as to connect to a first light emitting element 31, a second light emitting element 32, a third light emitting element 33 and a fourth light emitting element 34. The first light emitting element 31, the second light emitting element 32, the third light emitting element 33, and the fourth light emitting element 34 can be white LED, red LED, blue LED and green LED, respectively, but the present invention is not limited thereto. The number of light emitting elements that can be controlled by the signal generation module 10 can be determined by the number of pins of the general purpose input/output (GPIO) module 40, but the present invention does not limit its number. With this, the signal generation module 10 adjusts the generation ratio of different control signals, that is, adjusts the frequency of the modulation signal and the generation ratio of the modulation signal, so as to control the different brightness of the light signals emitted by the first light emitting element 31, the second light emitting element 32, the third light emitting element 33 and the fourth light emitting element 34.

In addition to the above-mentioned components, the circuit of the present invention may also include other circuit components, such as resistors, capacitors, or inductors, for purposes such as voltage division, voltage stabilization, or switching. Since the technology of other circuit elements is not the focus of the present invention, it will not be depicted hereafter.

From the above description, the light source adjustment system 1, 1′ in the present invention can use different frequencies and generation ratios of different control signals 51, 52, 53 to adjust the brightness of the light signal emitted by the light emitting element 30 to achieve the best near-stepless dimming control method using the lowest cost and the most streamlined circuit.

It should be noted that the preferred embodiments of the present invention described above are merely illustrative. To avoid redundancy, all the possible combinations of changes are not documented in detail. However, it shall be understood by those skilled in the art that each of the modules or elements described above may not be necessary. For the implementation of the present invention, the present invention may also contain other detailed, conventional modules or elements. Each module or component is likely to be omitted or modified depending on the needs. Other modules or elements may not necessarily exist between two of any modules. All without departing from the scope of the invention are defined solely by the appended claims

What is claimed is:

1. A light source adjustment system, comprising:
a signal generation module, which is used for generating a control signal;
a switch circuit, which is electrically connected to the signal generation module for determining whether a power signal is outputted according to the control signal; and
a light emitting element, which is electrically connected to the switch circuit for emitting a light signal according to the power signal;
wherein the signal generation module adjusts a generation ratio of the control signal so as to control a brightness of the light signal.

2. The light source adjustment system as claimed in claim 1, wherein the control signal is a modulation signal, and the signal generation module adjusts the frequency of the modulation signal to control a brightness of the light signal.

3. The light source adjustment system as claimed in claim 2, wherein the switch circuit is a metal-oxide-semiconductor field effect transistor (MOSFET).

4. The light source adjustment system as claimed in claim 2, wherein the light emitting element can be a white LED, a red LED, a blue LED or a green LED.

5. The light source adjustment system as claimed in claim 2, wherein the signal generation module is connected to the switch circuit through a general purpose input/output (GPIO) module.

6. The light source adjustment system as claimed in claim 2, wherein the signal generation module is a Bluetooth low energy (BLE) module or a microcontroller unit (MCU).

7. The light source adjustment system as claimed in claim 1, wherein the switch circuit is a metal-oxide-semiconductor field effect transistor (MOSFET).

8. The light source adjustment system as claimed in claim 1, wherein the light emitting element can be a white LED, a red LED, a blue LED or a green LED.

9. The light source adjustment system as claimed in claim 1, wherein the signal generation module is connected to the switch circuit through a general purpose input/output (GPIO) module.

10. The light source adjustment system as claimed in claim 1, wherein the signal generation module is a Bluetooth low energy (BLE) module or a microcontroller unit (MCU).
